(19) United States
(12) Patent Application Publication
(10) Pub. No.: US 2017/0203948 A1
(43) Pub. Date: Jul. 20, 2017

(54) Refrigerator Having A Water Dispensing Assembly And A Phase Change Material

(71) Applicant: BSH HAUSGERAETE GMBH, MUENCHEN (DE)

(72) Inventors: FRANK BAILLY, NEU-ULM (DE); BERND BRABENEC, GIENGEN (DE); MICHAEL LAUDAHN, GUNDELFINGEN (DE)

(21) Appl. No.: 15/326,717

(22) PCT Filed: Jun. 30, 2015
(86) PCT No.: PCT/EP2015/064828

§ 371 Date: Jan. 17, 2017

(30) Foreign Application Priority Data
Jul. 16, 2014 (DE) 10 2014 213 800.0

(51) Int. Cl. B67D 1/08; B67D 1/00; C09K 5/06; F25D 23/02

(52) U.S. Cl. CPC B67D 1/0857; F25D 23/028; B67D 1/0009; C09K 5/066; B67D 1/0021

(57) ABSTRACT

A refrigerator includes a liquid dispensing assembly having a dispensing reservoir for holding liquid and a dispensing unit for dispensing a cold drink containing the liquid. At least one wall of the dispensing reservoir includes a phase change material and/or at least one element including a phase change material is integrated into the dispensing reservoir.

The invention relates to a refrigerator comprising a water dispensing assembly, which has a dispensing reservoir for holding liquid and a dispensing unit for dispensing a cold drink containing the liquid.

Such a device, which has an ice or water dispenser, is known for example from DE 20 2006 013 708 U1. The ice or water dispenser in that device is integrated in a door, arranged separately from any receiving space in which food is placed. The water tank is connected to an outlet belonging to a dispensing device, by means of which the water can then be channeled out from the water tank, and in particular can then be fed into a drinking vessel arranged in the recess. The water tank is connected via a feed line and a shutoff valve to a liquid feed external to the device in the form of a domestic water supply. The water tank is relatively small in the known embodiment. In addition, because of the connection to the domestic water supply, it is only possible to a limited extent to feed even already relatively cool liquid into the dispensing reservoir. The ability to provide a continuous, sufficient quantity of adequately cooled liquid on the one hand, and to achieve very rapid cooling in the dispensing reservoir on the other, is therefore limited.

An object of the present invention is to create a refrigerator in which a liquid that can be consumed by a user in the form of a cold drink is lastingly cooled as evenly as possible.

This object is achieved by a refrigerator which has the features described in claim 1.

An inventive refrigerator comprises a liquid dispensing assembly, which has a dispensing reservoir for holding liquid. The liquid dispensing assembly additionally comprises a dispensing unit for dispensing a cold drink containing the liquid. An essential concept of the invention is that at least one wall of the dispensing reservoir comprises a phase change material and/or at least one separate element comprising a phase change material is integrated into the interior of the dispensing reservoir.

The invention therefore provides that the dispensing reservoir itself is designed at least in some areas as a latent heat accumulator, or an element integrated into the interior of the dispensing reservoir, which element is then a separate component to the dispensing reservoir, is such a latent heat accumulator.

A latent heat accumulator is a device, which can store thermal energy, with low loss, with many repeat cycles and over long periods. To this end use is made of so-called phase change materials (PCMs), whose latent fusion heat, dissolution ii heat or absorption heat is significantly greater than the heat that they can store due to their normal specific heat capacity (without the phase transition effect). The local installation of such a latent heat accumulator is achieved in a highly space-saving manner by the invention. In addition, by specifying the location where the phase change material can be formed, a direct effect on the liquid in the dispensing reservoir is also achieved so that a very rapid cooling of the liquid contained in the dispensing reservoir to the desired temperature is achieved. In addition, this inventive embodiment also enables the cool temperature of the liquid in the dispensing reservoir to be maintained for a very long time.

Provision is preferably made so that the phase change material has a phase change point at a temperature between 3° C. and 6° C. It is precisely at these temperatures that, in conventional embodiments and known implementations, it is possible only to a limited extent to adjust this temperature and furthermore to maintain it over a longer period.

Provision is preferably made so that at least one wall of the dispensing reservoir is coated with a phase change material on an interior surface of the dispensing reservoir and/or on an outer surface of the dispensing reservoir. With such an embodiment, a very thin component can be formed with the phase change material and, with such a coating, the basic volume of the dispensing reservoir is further increased negligibly or the inner volume is reduced only negligibly. In addition, such a coating enables the phase change material to be attached permanently and securely to such a wall.

Provision is preferably made so that at least one wall of the dispensing reservoir is formed completely from a phase change material. No additional step in the manufacture of the dispensing reservoir, for example to attach a film or a coating, is required for the phase change material to be thus integrated into the wall of the dispensing reservoir. In addition, the phase change material is also evenly embedded into the material of the wall in this embodiment.

Provision can also be made so that a plurality of elements comprising the phase change material as fill, in particular as granulate fill, is integrated into the interior of the dispensing reservoir. In such an embodiment these elements can then also be exchanged or the quantity of requisite elements can be individually increased or reduced, so that the cooling effect can be individually adjusted and thus the cooling temperature can also be individually adjusted.

In an advantageous embodiment, provision is made so that the phase change material is integrated into a polymer material and thus a composite material is formed. This embodiment is particularly advantageous, since a certain support construct for the phase change material is also thus achieved. In a particularly advantageous way, as a result of the integration of the phase change material into a polymer material a leakage protection of the phase change material is also achieved, which—especially when embodied as separate elements, which can then be incorporated into the interior of the dispensing reservoir or even in a coating on an interior surface of a wall of the dispensing reservoir—is particularly advantageous. Provision is preferably made so that such a composite material is designed as a film, plate or injection-molded part and at least one wall of the dispensing reservoir comprises such a film and/or at least one wall of the dispensing reservoir is designed as such a plate or injection-molded part.

Provision is preferably made so that the composite material is formed into balls and introduced into the dispensing reservoir as fill.

In an advantageous embodiment the composite material may be a phase change material composite incorporated into a matrix. Such a material may in particular be the material “PolymerTherm”. This material in particular allows for improved mechanical postprocessing, for example for cleaning of the dispensing reservoir, without the phase change material being able to escape or leak. In addition, failure of the casing in the event of heavy stress occurring in polymer processing processes can be prevented in this instance, and a specific shaping, for example production of a plate or an injection-molded part, is only possible as a result. The material “PolymerTherm” is available and applicable immediately as a ready-finished material and therefore does not need to be first additionally incorporated into a substrate in a further costly step.

Compared to the use of water or salt hydrates or corresponding mixtures as phase change materials, which indeed have a high, volume-based storage capacity, the use of the material “PolymerTherm” also has the further advantage that no external encapsulation or incorporation into a storage system is necessary. Furthermore, signs of corrosion do not occur. In addition, there is no significant reduction in storage capacity caused by changes in the composition. In the case of phase change materials based on salt hydrates, any water loss results in a significant reduction in storage capacity. With the material “PolymerTherm”, there is no integration of water or salt hydrates in polymers with the necessary cycle stability.

The very design of this material as a granulate fill means that the cooling of the liquid is particularly effective, since the granulate provides a particularly large surface area for heat exchange with the medium flowing through or with the liquid.

Other features of the invention will emerge from the claims, the figures and the descriptions of the figures. The features and combinations of features specified here in the description and the features and combinations of features specified below in the descriptions of the figures and/or illustrated in isolation in the figures can be used not only in the combinations indicated, but also in other combinations or in isolation without departing from the framework of the invention. There are therefore also embodiments of the invention that may be regarded as included and disclosed, which are not explicitly shown in the figures or explained, but which emerge and can be produced by separate combinations of features from the explained embodiments.

Exemplary embodiments of the invention will be explained subsequently on the basis of schematic drawings. In these:

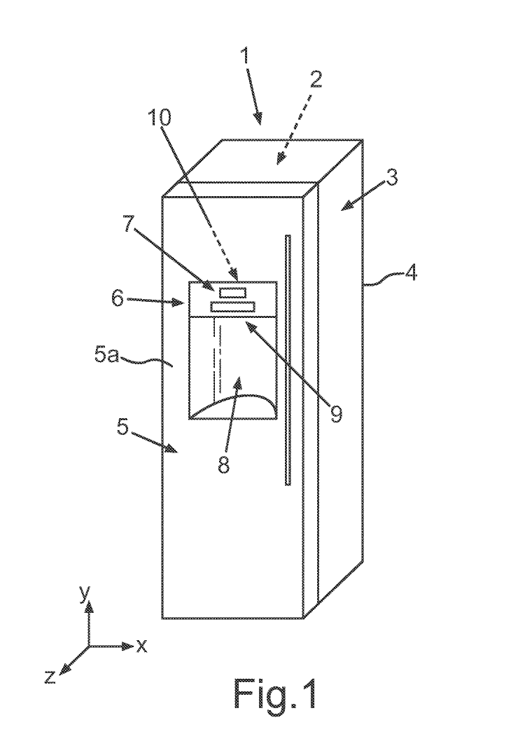

FIG. 1 shows a perspective representation of an exemplary embodiment of an inventive refrigerator;

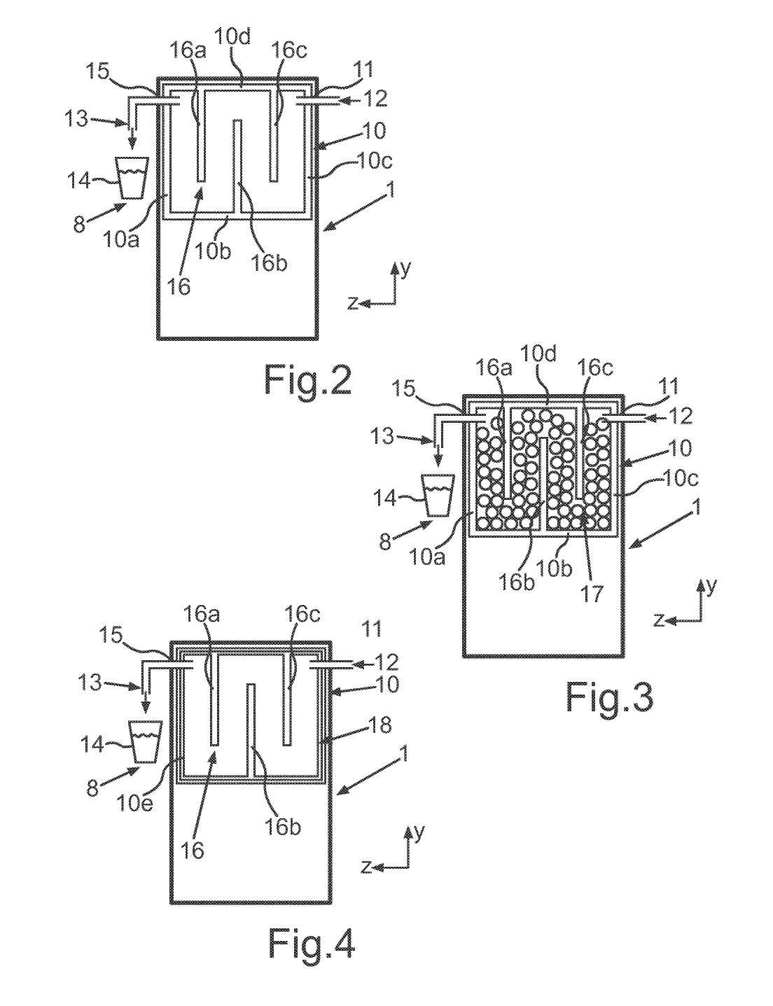

FIG. 2 shows a schematic cross-section of a first exemplary embodiment of the refrigerator with a specific liquid dispensing assembly;

FIG. 3 shows a schematic cross-section of a further exemplary embodiment of an inventive refrigerator; and

FIG. 4 shows a schematic cross-section through a third exemplary embodiment of an inventive refrigerator.

The same elements or elements with the same functions are provided with the same reference labels in the figures.

FIG. 1 is a perspective representation showing a refrigerator 1, which is thus designed only for the chilling of foodstuffs placed in a holding cavity 2, such as food and drink, but does not have a freezer compartment. The refrigerator 1 additionally comprises a housing 3, which delimits the holding space 2. The housing 3 comprises a base frame 4, on which a door 5 is arranged in a pivotable manner.

The refrigerator 1 additionally comprises a liquid dispensing assembly 6, which is designed for dispensing chilled liquid as a cold drink. The liquid dispensing assembly 6 is arranged in the housing 3, where it may be arranged with at least partial components in the holding space 2 and/or with at least partial components at least in one wall of the housing 3, in particular in the door 5 or can be arranged completely in such a wall, in particular the door 5, and is thus arranged separately from the holding space 2.

The liquid dispensing assembly 6 comprises an operating and display unit 7, which is accessible and visible via a front side of the door 5. A user of the refrigerator 1 can then place a collection vessel, for example a drinking glass, in a recess 8 of the door 5, in order to dispense the cold drink, and can then introduce the cold drink into said drinking vessel via an illustrated dispensing device or dispensing unit 9 of the liquid dispensing assembly 6.

The liquid dispensing assembly 6 comprises, in addition to the aforementioned dispensing unit 9, a dispensing reservoir 10 connected to the dispensing unit 9, in particular a liquid-conducting dispensing reservoir 10, in which liquid, in particular water, is contained. The dispensing unit 9 extends partially into the recess 8 and is arranged in a dispensing location directly below the operating and display unit 7, so that the cold drink flows as if from above into the drinking vessel placed in the recess 8 via the dispensing location. The dispensing of the cold drink can be generated via operating elements of the operating and display unit 8.

FIG. 2 shows a schematically simplified longitudinal section and thus a first exemplary embodiment of the refrigerator 1 in the y-z plane. It should be mentioned that, due to heavy simplification, the size ratios are not relevant and the liquid dispensing assembly 6, in particular the dispensing reservoir 10, is shown oversized.

It can be seen that the dispensing reservoir 10 has an inlet 11, via which liquid in the form of water can be fed via an external supply network, for example a domestic water supply network 12. As mentioned above, the dispensing reservoir 10 can also be completely arranged in the door 5. The already mentioned dispensing location 13 is arranged on the outer surface 5a of the side of the dispensing reservoir 10 facing the door 5, via which dispensing location the medium flowing out of the dispensing reservoir 10 in the form of the cold drink can flow into the drinking vessel 14 placed in the recess 8.

In the embodiment shown here, it is provided that at least one wall 10a, 10b, 10c, 10d of the dispensing reservoir 10 comprises a phase change material. Provision is preferably made so that at least one of these walls 10a to 10d is already manufactured as a plate from a composite material, which comprises a phase change material that is integrated into a polymer material, this material of one wall 10a to 10d preferably being “PolyTherm”.

As FIG. 2 further shows, the dispensing reservoir 10 is designed so that the path taken by the liquid from the inlet 11 to an outlet 15 passes through a labyrinth 16, the bars forming the labyrinth being formed on the interior surfaces of walls 10a to 10d . The bars 16a, 16b and 16c are preferably arranged so that the labyrinth takes a winding route up and down in a vertical direction.

FIG. 3 shows a vertical cross-section corresponding to the one in FIG. 2, with a further exemplary embodiment of the refrigerator 1 being illustrated. In contrast to FIG. 2, provision is made here so that a plurality of separate elements comprising a phase change material are integrated on the interior of the dispensing reservoir 10. A granulate fill 17 comprising a plurality of balls or beads is preferably incorporated therein, the granulate fill 17 being designed so that the individual, separate balls are formed from the composite material, in particular “Polytherm”.

FIG. 4 is a further cross-section similar to FIG. 2 and FIG. 3 showing a further exemplary embodiment of an inventive refrigerator 1. In the embodiment shown in FIG. 4, in contrast to FIG. 2 and FIG. 3, provision is made so that a coating 18 comprising a phase change material is formed on an interior surface 10e of at least one wall 10a to 10d . Provision can be made so that the coating is applied by a specific coating process or provided as a film and is applied to said interior surface 10c. Provision is preferably made so that the coating or the film is made from the composite material “Polytherm”.

Provision can also be made so that the exemplary embodiments explained according to FIG. 2 to FIG. 4 can be configured into any combinations to form further exemplary embodiments so that, for example in FIG. 2, the fill 17 and/or at least one interior surface 10e of a wall 10a to 10d also comprises a corresponding coating 18 in addition. Provision may accordingly also be made in the embodiment in FIG. 3 so that at least one wall 10a to 10d is designed according to the embodiment in FIG. 2 and/or at least one interior surface 10e of a ii wall 10a to 10d comprises a coating 18.

With reference to only walls 10a to 10d being specified, this is due to the illustration in FIG. 2 to FIG. 4; the reservoir 10 does of course have six walls, which may be structured accordingly.

The phase change material is preferably designed in such a way that the cold drink is dispensed and introduced into the drinking glass 14 with a temperature between 3° C. and 6° C. The cold drink can only be made from the liquid in the dispensing reservoir 10, but may comprise a mixture of different components. For this purpose the refrigerator 1 may have an additional reservoir by means of which a further component for producing the cold drink is then contained in addition to the liquid in the dispensing reservoir 10 and can be mixed with the liquid in the dispensing reservoir 10.

### LIST OF REFERENCE CHARACTERS

1 Refrigerator

2 Holding space

3 Housing

4 Base frame

5 Door

5a Outer surface

6 Liquid dispensing assembly

7 Operating and display unit

8 Recess

9 Dispensing unit

10 Dispensing reservoir

10a to 10d Wall

10e Interior surface

11 Inlet

12 Domestic water supply

13 Dispensing location

14 Drinking vessel

15 Outlet

16 Labyrinth

16a to 16c Bar

17 Granulate fill

18 Coating

1-9. (canceled)

10. A refrigerator, comprising:
a liquid dispensing assembly including a dispensing reservoir for holding a liquid and a dispensing unit for dispensing a cold drink containing the liquid;
said dispensing reservoir including at least one of:
at least one wall having a phase change material, or
at least one separate element having a phase change material and being integrated into said dispensing reservoir.

11. The refrigerator according to claim 10, wherein said phase change material has a phase change point in a temperature range between 3° C. and 6° C.

12. The refrigerator according to claim 10, wherein said at least one wall of said dispensing reservoir has at least one of an interior surface or an exterior surface being coated with said phase change material.

13. The refrigerator according to claim 10, wherein said at least one wall of said dispensing reservoir is formed from a material including said phase change material.

14. The refrigerator according to claim 10, wherein said at least one separate element integrated into said dispensing reservoir is a fill.

15. The refrigerator according to claim 14, wherein said fill is a granulate fill.

16. The refrigerator according to claim 10, wherein said phase change material is integrated into a polymer material to form a composite material.

17. The refrigerator according to claim 16, wherein said composite material is formed as at least one of:
a film included in said at least one wall of said dispensing reservoir or a plate or an injection-molded part forming said at least one wall of said dispensing reservoir.

18. The refrigerator according to claim 16, wherein said composite material is formed into balls and is introduced into said dispensing reservoir as a fill.

19. The refrigerator according to claim 10, wherein said dispensing reservoir includes a liquid inlet, a liquid outlet, an interior and a labyrinth structure formed in said interior and providing a path for the liquid from said liquid inlet to said liquid outlet.
